(19) United States
(12) Patent Application Publication
(10) Pub. No.: US 2017/0074083 A1
(43) Pub. Date: Mar. 16, 2017

(54) STATIC GAS SEPARATOR FOR DOWNHOLE ELECTRIC SUBMERSIBLE PUMP

(71) Applicant: Stanley Filter Co., LLC, Tulsa, OK (US)

(72) Inventors: John L. Morton, III, Pryor, OK (US); John L. Morton, JR., Okmulgee, OK (US)

(21) Appl. No.: 15/008,118

(22) Filed: Jan. 27, 2016

Related U.S. Application Data
(60) Provisional application No. 62/219,459, filed on Sep. 16, 2015.

(51) Int. Cl. E21B 43/38; E21B 43/12; B01D 19/00

(52) U.S. Cl. CPC E21B 43/38; B01D 19/0057; B01D 19/0031; E21B 43/128

(57) ABSTRACT

A static gas separator interposed between an electric submersible pump and a downhole motor to separate entrained gas from production fluid in a subterranean well. The gas separator includes an elongate cylindrical mandrel concentrically surrounded an outer static filter sleeve. A base member is attached at a lower end of the gas separator and includes a flange for connection with a mating flange on the pump. The upper end of the gas separator includes a head member attached thereto and includes a flange for connection with a mating flange on the motor. The gas separator includes a plurality of radially aligned, axial flow intakes in fluid communication with a hollow interior of the head member and a separating annulus formed between the outer static filter sleeve and the mandrel. The gas separator may also include radially protruding helical fins or vanes that impart a centrifugal force or vortex to the production well fluid flowing through the annulus.

### CROSS REFERENCE TO RELATED APPLICATIONS

This application claims the benefit of and priority to U.S. Provisional Patent Application Ser. No. 62/219,459 filed Sep. 16, 2015, which is incorporated by referenced herein in its entirety.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### REFERENCE TO A SEQUENCE LISTING, A TABLE, OR A COMPUTER PROGRAM LISTING APPENDIX

Not Applicable.

### STATEMENT REGARDING PRIOR DISCLOSURES BY THE INVENTOR OR A JOINT INVENTOR

Not Applicable.

### BACKGROUND OF THE INVENTION

1. Field of the Invention

The invention generally relates to static gas separators for oil and gas wells, and more particular to a static gas separator interposed between an electric submersible pump and motor for separating gas from oil and gas well fluid prior to reaching the pump.

2. Description of the Related Art

Oil and gas wells and water wells include a wellbore extending into a well to some depth below the surface. Typically, the wellbore is lined with casing to strengthen the walls of the borehole. To further strengthen the walls of the borehole, the annular area formed between the casing and the borehole is typically filled with cement to permanently set the casing in the wellbore. The casing is then perforated to allow production fluids to enter the wellbore and be retrieved at the surface of the well.

Various types of downhole equipment, such as pumps and similar devices, are used to move production fluids from within the wellbore to the surface. A typical downhole arrangement would include a string composed of a series of tubes or tubing suspended from the surface. One type of well-known pump is a downhole electrical submersible pump (ESP). The ESP either includes or is connected to a downhole motor, which is sealed so that the whole assembly is submerged in the fluid to be pumped. The ESP assembly is driven by a common shaft powered by the motor, with the pump located at the upper end of the assembly. The motor is connected to a power source at the surface and operates beneath the level of the fluid downhole in order to pump the fluid to the surface.

Most oil wells typically also produce some free and/or entrained gas along with the well fluid being pumped. ESPs have dramatically lower efficiencies with significant fractions of gas, and at some point, the pump may become “gas locked” and damage to the pump and/or motor may result. For this reason, it has been found desirable to provide the ESP with a gas separator adapted to remove the gaseous substances from the fluid being pumped to insure efficient and continuous operation of the motor and pump assembly.

It is therefore desirable to provide an improved static gas separator for use with an electrical submersible pump and motor assembly that prevents cycling, gas lock, and cavitation, resulting in a stable motor load and increased run life.

Other advantages and features will be apparent from the following description, and from the claims.

### SUMMARY OF THE INVENTION

In general, the invention relates to a static gas separator configured to be interposed between an electric submersible pump and a downhole motor. The gas separator includes an elongated cylindrical mandrel juxtaposed between a base member and a head member. The mandrel has a drive shaft extending longitudinally through an axial bore, and a plurality of internal rotary bearing assemblies are positioned within the axial bore of the mandrel and circumscribing the drive shaft. The drive shaft of the gas separator may include terminal splines for connection with respective coaxial drive shafts of the pump and the motor.

The base member has a flange configured for connection with a mating flange on the motor. The base member may include a hollow interior within which the drive shaft of the gas separator is coupled to the drive shaft of the motor. The base member may also have an upstanding circular flange coupled to the mandrel, and in particular an inner face of the upstanding circular flange of the base member may include internal threads for engaging peripheral threads on a lower end of the mandrel. The inner face of the upstanding circular flange also can have at least one sealing element or sealing assemblies respectively supported within a circular seal groove. An outer face of the upstanding circular flange of the base member can have an annular stop shoulder engaging the outer static filter sleeve. Moreover, the base member may include one or more radially aligned, axial flow inlets in fluid communication with the separating annulus.

The head member has a flange configured for connection with a mating flange on the pump. The head member also has a plurality of radially aligned, axial flow inlets in fluid communication with a separating annulus formed between the mandrel and an outer static filter sleeve that circumferentially surrounds the mandrel. Similar to the base member, the head member may include a hollow interior within which the drive shaft of the gas separator is coupled to the drive shaft of the pump. The flow inlets of the head member may also be in fluid communication with the hollow interior and the separating annulus of the gas separator. In addition, the head member can include an upstanding circular flange coupled to the mandrel, such as by an inner face of the upstanding circular flange of the head member having internal threads for engaging peripheral threads on an upper end of the mandrel. The inner face of the upstanding circular flange of the head member may also include at least one sealing element or sealing assembly respectively supported within a circular seal groove. An outer face of the upstanding circular flange of the head member may also include an annular stop shoulder engaging the outer static filter sleeve.

The bearing assemblies of the gas separator may be journal or plain bearings or sleeve bearings, and can be constructed with a carbide sleeve surrounding and mounted to the drive shaft. The bearing assemblies may utilize a bushing supporting the sleeve, and a bushing shell between the bushing and the mandrel.

Additionally, the gas separator can include at least one helical fin or vane positioned within the annulus and radially protruding from an outer face of the mandrel. The fins or vanes may be positioned adjacent to the head member and/or the base member or may extend from a lower end to an upper end of the mandrel.

### BRIEF DESCRIPTION OF THE DRAWINGS

FIG. 1 is a sectional, partial cutaway view of downhole equipment incorporating a static gas separator disclosed herein connected in a production string;

FIG. 2 is a side elevation view of an example of a static gas separator in accordance with an illustrative embodiment of the invention disclosed herein;

FIG. 3 is a cross-sectional view along line A-A of the gas separator shown in FIG. 1;

FIG. 4 is a perspective view of the gas separator shown in FIG. 3;

FIG. 5 is an exploded view of area B of the gas separator shown in FIG. 3;

FIG. 6 is an exploded view of area C of the gas separator shown in FIG. 3;

FIG. 7 is a top plan view of the head member shown in FIG. 6;

FIG. 8 is a top plan view of the base member shown in FIG. 5;

FIG. 9 is a rear perspective view of another example of a static gas separator having a helical fin or vane in accordance with another illustrative embodiment of the invention disclosed herein.

### DETAILED DESCRIPTION OF THE INVENTION

The embodiments discussed herein are merely illustrative of specific manners in which to make and use this invention and are not to be interpreted as limiting in scope.

While the invention has been described with a certain degree of particularity, it is to be noted that many modifications may be made in the details of the construction and the arrangement of the elements and components of the devices and/or in the sequences and steps of the methods without departing from the scope of this disclosure. It is understood that the devices and methods are not limited to the embodiments set forth herein for purposes of exemplification.

The description of the invention is intended to be read in connection with the accompanying drawings, which are to be considered part of the entire written description of this invention. In the description, relative terms such as “front,” “rear,” “lower,” “upper,” “horizontal,” “vertical,” “above,” “below,” “up,” “down,” “top” and “bottom” as well as derivatives thereof (e.g., “horizontally,” “downwardly,” “upwardly” etc.) should be construed to refer to the orientation as then described or as shown in the drawings under discussion. These relative terms are for convenience of description and do not require that the machine be constructed or the method to be operated in a particular orientation. Terms, such as “connected,” “connecting,” “attached,” “attaching,” “join” and “joining” are used interchangeably and refer to one structure or surface being secured to another structure or surface or integrally fabricated in one piece, such as by welding, binding with adhesives, riveting, threaded fasteners, or bending in the form of a crimped seam.

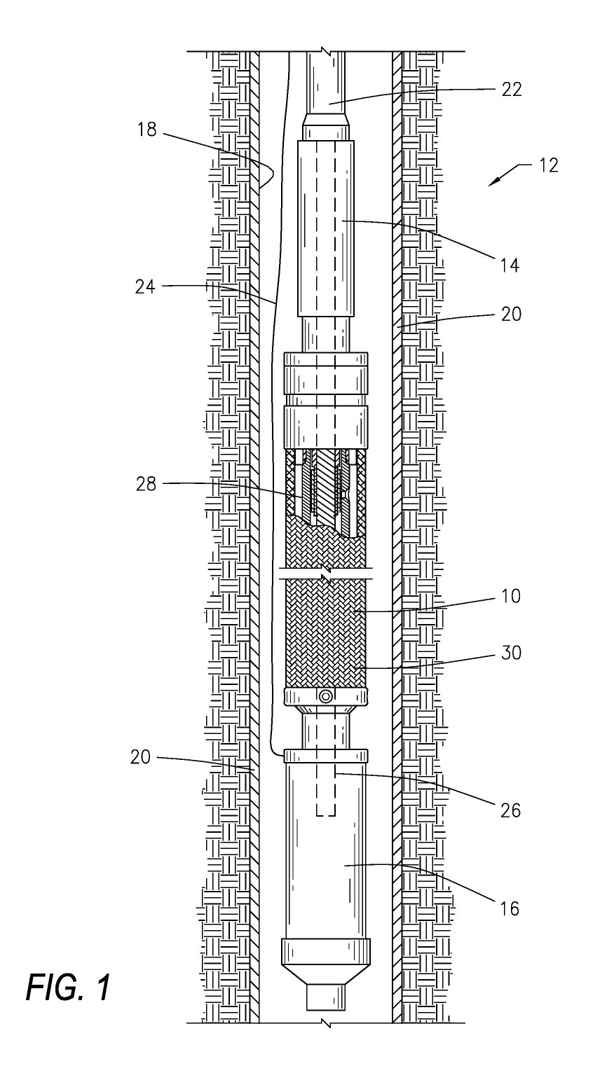

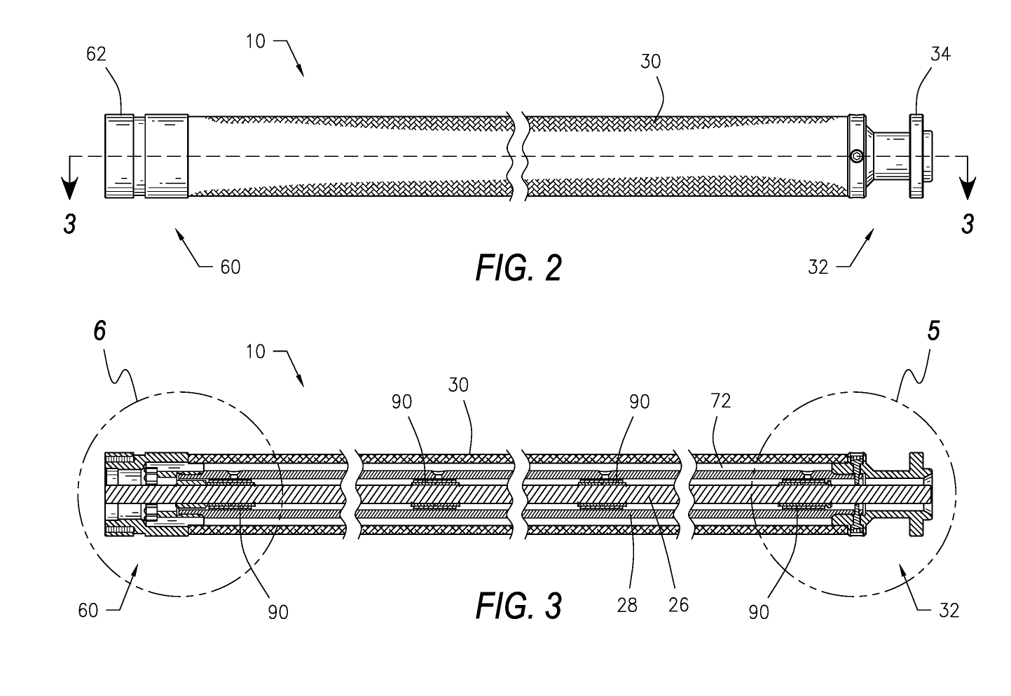

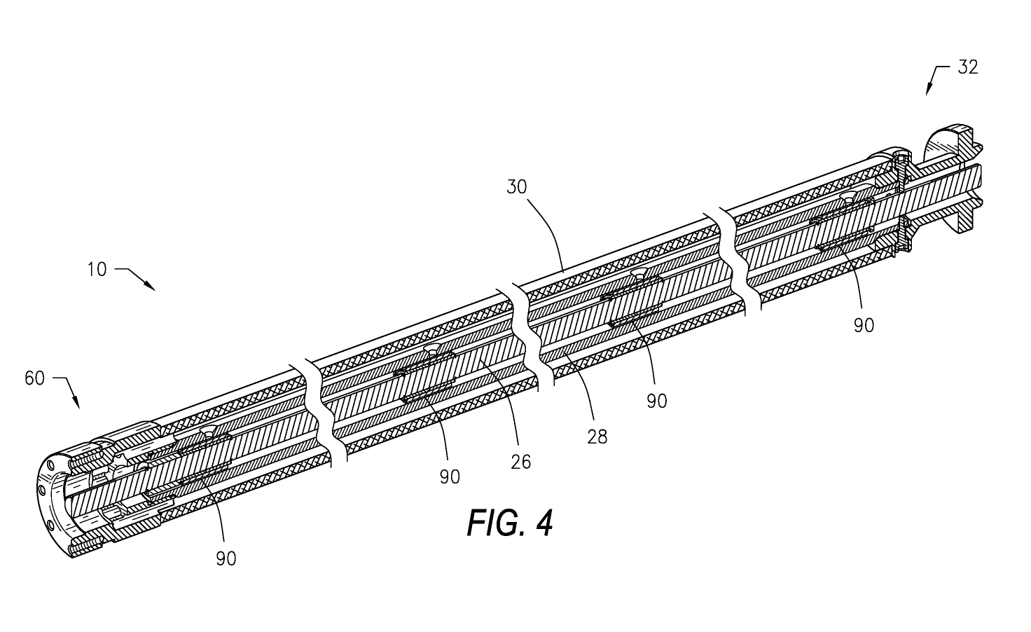

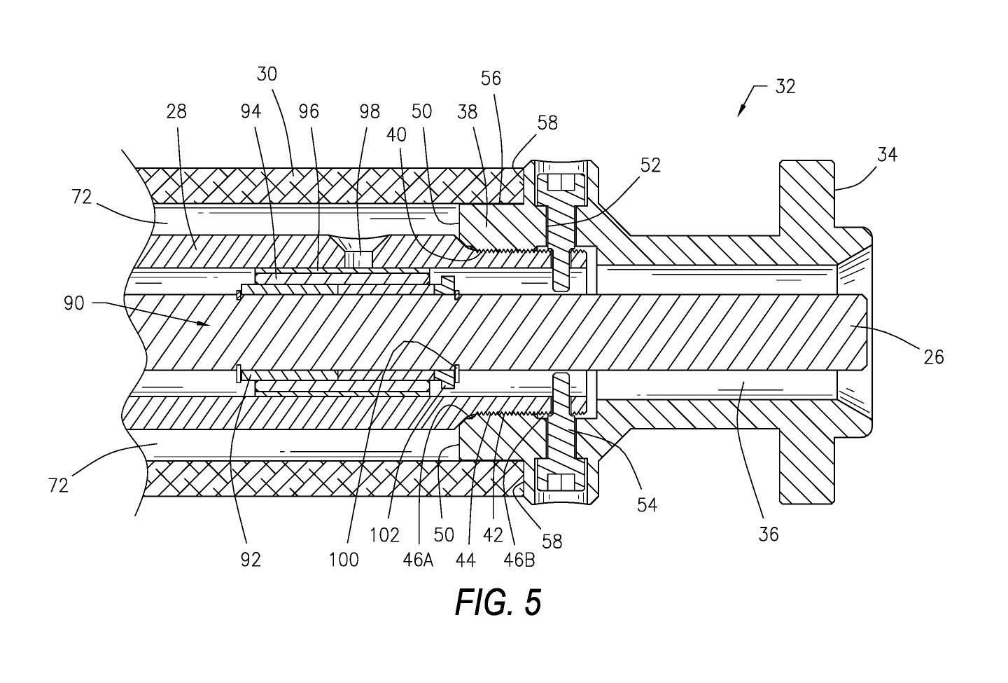

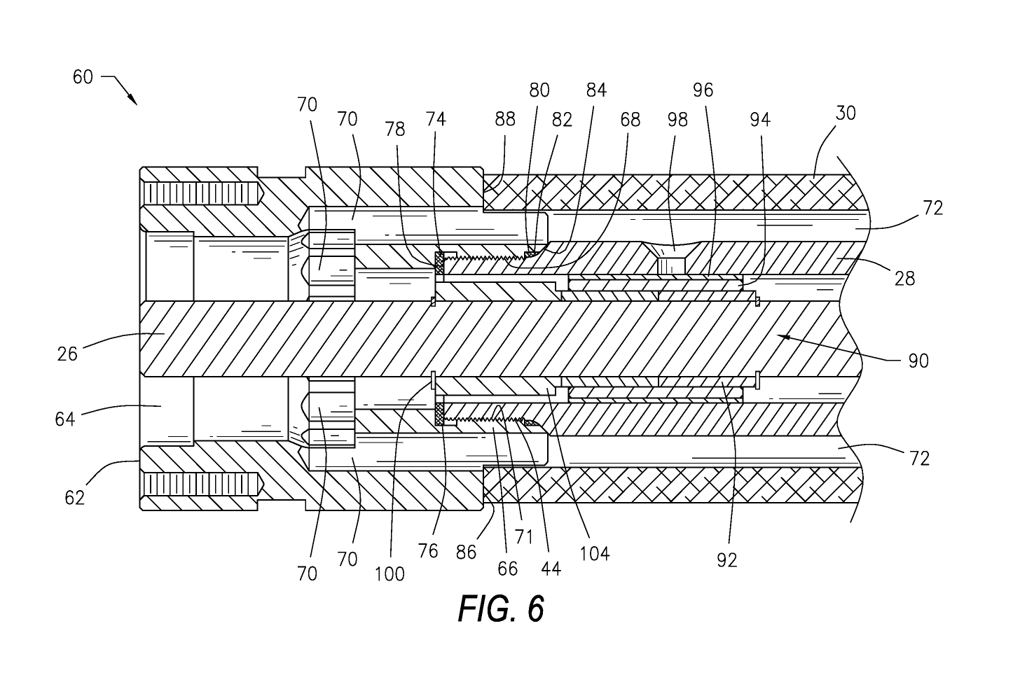

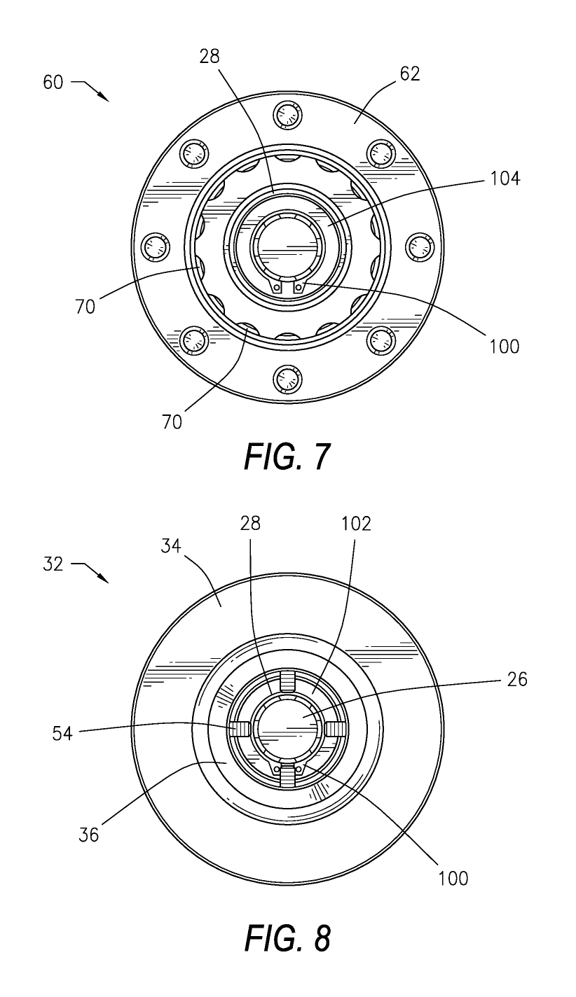

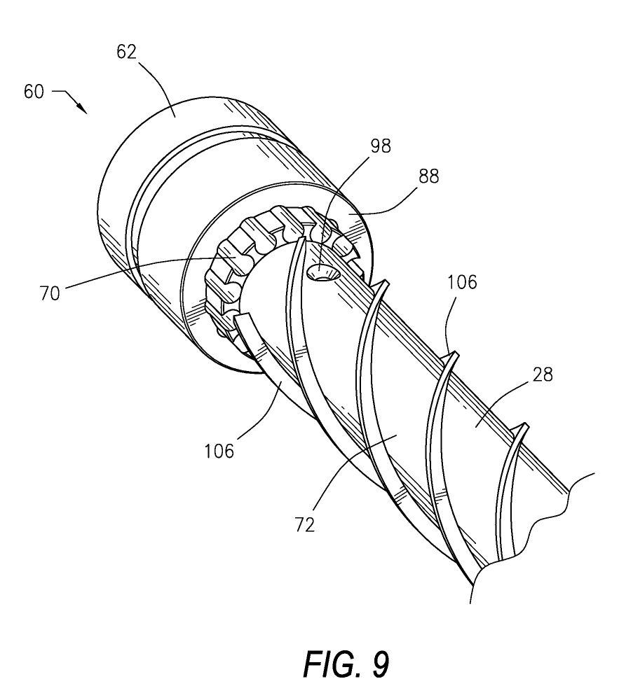

Referring to the figures of the drawings, wherein like numerals of reference designate like elements throughout the several views and initially to FIG. 1, a static gas separator 10 for a subterranean oil and gas well 12 that is interposed between an electric submersible pump 14 and a downhole motor 16 for separating gas from well production fluids prior to reaching the pump 14. Well production fluids may include oil, gas and water or combinations thereof. The subterranean well 12 includes a casing 18 which extends from the surface downhole. The casing 18 includes perforations 20 that allow production fluids to pass through the casing 18. The electrical submersible pump 14 is lowered into the well 12 beneath the level of fluid, with the gas separator 10 also totally submerged therein. The pump 14 is suspended from a string 22 which may be composed of a series of tubes or tubing suspended from the surface, such as from a rig or derrick. The pump 14 includes the motor 16 that is sealed from the fluids. The motor 16 is powered by electrical energy supplied by an energy source (not shown) at the surface, such as a generator, via a power cable 24. The pump 14 is driven by the motor 16 through a coaxial drive shaft 26 extending longitudinally through an elongated cylindrical mandrel 28 of the gas separator 10. Suitable splines are provided on the drive shaft 26 for appropriate connections with the respective shafts of the pump 14 and motor 16. The pump 14, the motor 16, and the gas separator 10 each have an external diameter less than an interior diameter of the casing 18, and form an integral unit for insertion within the casing 18 of the oil or gas well 12. When received within the well casing 18, an outer static filter sleeve 30 of the gas separator 10 is spaced relative to the inner wall of the well casing 18 so as to permit the flow of well fluid therebetween. Downhole fluid is forced by the motor 16 upward through axial flow inlets 70 of the gas separator 10 to the pump 14, which draws the fluid through the string 22 to the surface where it is collected in a tank (not shown) or otherwise delivered by a pipeline or other known means.

The gas separator 10 includes a base member 32 at a lower end thereof with a flange 34 for connection with a mating flange of the motor 16 in a conventional manner. The base member 32 includes a hollow interior 36 within which the drive shaft 26 is splined or otherwise coupled to the shaft of the motor 16. The upper end of the base member is provided with an upstanding circular flange 38 having an inner face 40 with internal threads 42 for engaging peripheral threads 44 on a lower end of the mandrel 28 of the gas separator 10. The inner face 40 of the upstanding circular flange 38 may also include an upper sealing element or sealing assemblies 46A and/or a lower sealing element or sealing assemblies 46B respectively supported within a circular seal groove 48A and 48B. As illustrated in the figures, the upper sealing element 46A is located adjacent an external stop shoulder 50 of the mandrel 28, while the lower sealing element 46B is located intermediate of the peripheral threads 42 of the inner face 40 of the circular flange 38 and a locking aperture 52, through which a locking screw 54 may be secured to the mandrel 28, in the base member 32. The sealing elements and/or sealing assemblies 46A and 46B can be constructed from elastomer and polymer materials capable of accomplishing effective sealing at normal to high operating temperatures and at all pressure ranges. An outer face 56 of the circular flange 38 of the base member 32 may include an annular stop shoulder 58 engaging the outer static filter sleeve 30 of the gas separator 10.

The gas separator 10 also includes a head member 60 at an upper end thereof with a flange 62 for connection with a mating flange on the housing of the pump 14. Similar to the base member 32, the head member 60 includes a hollow interior 64 within which the drive shaft 26 is splined or otherwise coupled to the shaft of the pump 14, and the lower end of the head member 60 is provided with an upstanding circular flange 66 having an inner face 68 with internal threads 71 for engaging peripheral threads 44 on a upper end of the mandrel 28 of the gas separator 10. The head member 60 of the gas separator 10 also includes a plurality of radially aligned, axial flow inlets 70 in fluid communication with the hollow interior 64 and a separating annulus 72 formed between the outer static filter sleeve 30 and the mandrel 28 of the gas separator 30. The inner face 68 of the upstanding circular flange 66 may also include a lower sealing element or sealing assembly 74 supported within a circular seal groove 76 located adjacent an external stop shoulder 78 of the mandrel 28. The inner face 68 of the circular flange 66 may also include an upper sealing element or sealing assembly 80 supported within an annular seal groove 82 located intermediate of the peripheral threads 71 of the inner face 68 of the circular flange 66 and an internal annular stop shoulder 84 in the base member 60. The upper and/or lower sealing elements or sealing assemblies 74 and/or 80 can be constructed from elastomer and polymer materials capable of accomplishing effective sealing at normal to high operating temperatures and at all pressure ranges. An outer face 86 of the circular flange 66 of the head member 60 may include an external annular stop shoulder 88 engaging the outer static filter sleeve 30 of the gas separator 10.

The gas separator 10 disclosed herein also includes a plurality of internal rotary bearing assemblies 90 positioned within the mandrel 28 and circumscribing the drive shaft 26 coupled between the pump 14 and the motor 16. The bearing assemblies 90 may be journal or plain bearings, sleeve bearings, or the like. The bearing assemblies 90 include a carbide sleeve 92 surrounding and mounted to the rotating shaft 26 so that the sleeve 92 rotates with the shaft 26. The sleeve 92 is supported by an insert 94, for example a bushing, and a bushing shell between the bushing and the mandrel 28. The sleeve 92 and shaft 26 rotate within the insert 94, which may be held in place by a race 96, tack weld or the like through an aperture 98 in the mandrel 28. The bearing assembly 90 is retained within the mandrel 28 using a snap ring 100 or the like. Moreover as illustrated in the figures, the bearing assembly 90 positioned adjacent to the base member 32 may include a bearing spacer 102 and the bearing assembly 90 positioned adjacent to the head member 60 may include an extended bearing spacer 104. Additional bearing assemblies 90 may be positioned within the mandrel 28 and circumscribing the drive shaft 26 to dampen vibration of the rapidly rotating drive shaft 26.

In addition, the mandrel 28 may include a plurality of radially protruding helical fins or vanes 106 that impart a centrifugal force or vortex to the well fluid flowing through the inlets 70 to the annulus 72. The helical fins or vanes 106 may be positioned adjacent the head member 60 and/or the base member 32 of the gas separator 10 or may extend from the lower end to the upper end of the mandrel 28 in the annulus 72. This centrifugal force tends to separate the liquid components from the gas components because of difference in densities, with the liquid components separating to the outer static sleeve 30 with the gas remaining near the mandrel 28.

Moreover, the base member 32 of the gas separator 10 may be constructed similarly to the head member 60 having one or more radially aligned, axial flow inlets 70 in fluid communication with the hollow interior 36 of the base member 32 and the separating annulus 72 formed between the outer static filter sleeve 30 and the mandrel 28. Furthermore, the gas separator 10 can be constructed as two or more separate and independent units joined in series depending upon well conditions.

Whereas, the invention has been described in relation to the drawings and claims, it should be understood that other and further modifications and formulations, apart from those shown or suggested herein, may be made within the scope of this invention.

What is claimed is:

1. A static gas separator configured to be interposed between an electric submersible pump and a downhole motor, said gas separator comprising:
an elongated cylindrical mandrel juxtaposed between a base member and a head member, said mandrel having a drive shaft extending longitudinally through an axial bore of said mandrel, said base member comprising a flange configured for connection with a mating flange on said motor, said head member comprising a flange configured for connection with a mating flange on said pump, said head member further comprising a plurality of radially aligned, axial flow inlets;
a plurality of internal rotary bearing assemblies positioned within said axial bore of said mandrel and circumscribing said drive shaft;
an outer static filter sleeve circumferentially surrounding said mandrel and juxtaposed between said base member and said head member; and
a separating annulus formed between said outer static filter sleeve and said mandrel of the gas separator, said flow inlets of said head member in fluid communication with said separating annulus.

2. The gas separator of claim 1 wherein said drive shaft further comprises terminal splines for connection with respective coaxial drive shafts of said pump and said motor.

3. The gas separator of claim 2 wherein said base member further comprises a hollow interior within which said drive shaft of said gas separator is coupled to said drive shaft of said motor.

4. The gas separator of claim 1 wherein said base member further comprises an upstanding circular flange coupled to said mandrel.

5. The gas separator of claim 4 further comprising an inner face of said upstanding circular flange of said base member having internal threads for engaging peripheral threads on a lower end of said mandrel.

6. The gas separator of claim 5 wherein said inner face of said upstanding circular flange further comprises at least one sealing element or sealing assemblies respectively supported within a circular seal groove.

7. The gas separator of claim 4 further comprising an outer face of said upstanding circular flange of said base member having an annular stop shoulder engaging said outer static filter sleeve.

8. The gas separator of claim 2 wherein said head member further comprises a hollow interior within which said drive shaft of said gas separator is coupled to said drive shaft of said pump.

9. The gas separator of claim 8 wherein said flow inlets are in fluid communication with said hollow interior and said separating annulus of said gas separator.

10. The gas separator of claim 1 wherein said head member further comprises an upstanding circular flange coupled to said mandrel.

11. The gas separator of claim 10 further comprising an inner face of said upstanding circular flange of said head member having internal threads for engaging peripheral threads on a upper end of said mandrel.

12. The gas separator of claim 11 wherein said inner face of said upstanding circular flange of said head member further comprises at least one sealing element or sealing assembly respectively supported within a circular seal groove.

13. The gas separator of claim 10 further comprising an outer face of said upstanding circular flange of said head member having an annular stop shoulder engaging said outer static filter sleeve.

14. The gas separator of claim 1 wherein said bearing assemblies are journal or plain bearings or sleeve bearings.

15. The gas separator of claim 14 wherein said bearing assemblies further comprise a carbide sleeve surrounding and mounted to said drive shaft, said bearing assemblies further comprising a bushing supporting said sleeve, and a bushing shell between said bushing and said mandrel.

16. The gas separator of claim 1 wherein said gas separator further comprises at least one radially protruding helical fin or vane positioned within said annulus.

17. The gas separator of claim 16 wherein said fin or vane is a plurality of helical fins or vanes radially protruding from an outer face of said mandrel.

18. The gas separator of claim 17 wherein said fins or vanes are positioned adjacent to said head member and/or said base member.

19. The gas separator of claim 17 wherein said fins or vanes extend from a lower end to an upper end of said mandrel.

20. The gas separator of claim 1 wherein said base member further comprises one or more radially aligned, axial flow inlets in fluid communication with said separating annulus.
